(19) United States
(12) Patent Application Publication
(10) Pub. No.: US 2011/0183867 A1
(43) Pub. Date: Jul. 28, 2011

(54) Polymer arrays for biofilm adhesion testing

(75) Inventors: Martyn Christopher Davies, Nottingham (GB); Morgan Alexander, Nottingham (GB); Paul Williams, Nottingham (GB); Robert Langer, Newton, MA (US); Daniel Anderson, Sudbury, MA (US); Andrew Urquhart, Nottingham (GB)

(73) Assignees: UNIVERSITY OF NOTTINGHAM, Nottingham (GB); MASSACHUSETTS INSTITUTE OF TECHNOLOGY, Cambridge, MA (US)

(21) Appl. No.: 12/672,528

(22) PCT Filed: Aug. 7, 2008
(86) PCT No.: PCT/GB2008/050674

§ 371 Date: Apr. 12, 2011

(30) Foreign Application Priority Data
Aug. 9, 2007 (GB) 0715491.7

(51) Int. Cl. C40B 30/00; C40B 30/06

(52) U.S. Cl. 506/10; 506/7

(57) ABSTRACT

This invention relates to a method of screening arrays of polymers having pre-determined surface energies. The polymer arrays of the present invention can be used to screen for microorganism adherence. More specifically the arrays can be used to screen for adherence of particular bacteria or fungi to particular polymers in the array. Furthermore, this invention relates to a method combining in-situ polymer synthesis with physico-chemical characterisation of the resulting polymer array and subsequent biological assays of bacterial or fungal adherence. This allows for high throughput screening and characterisation of candidate polymers which are not susceptible to bacterial or fungal adherence or which can be used to support bacterial or fungal adherence where such is required. The arrays can also be used to screen for inhibition or promotion of biofilm formation.

This invention relates to a method of screening arrays of polymers having pre-determined surface energies. The polymer arrays of the present invention can be used to screen for microorganism adherence. More specifically the arrays can be used to screen for adherence of particular bacteria or fungi to particular polymers in the array. Furthermore, this invention relates to a method combining in-situ polymer synthesis with physico-chemical characterisation of the resulting polymer array and subsequent biological assays of bacterial or fungal adherence. This allows for high throughput screening and characterisation of candidate polymers which are not susceptible to bacterial or fungal adherence or which can be used to support bacterial or fungal adherence where such is required. The arrays can also be used to screen for inhibition or promotion of biofilm formation.

The surface controls many important material performance properties such as biocompatibility and wettability. Surface properties cannot be assumed from bulk properties and thus are usually only determined by direct measurement. Important surface properties include wetting, frictional resistance, wear resistance, absorptivity, adsorption, brightness and luminescence.

Surface energy (γ) is a fundamental property of surfaces and is defined as the energy required to form an additional unit area of surface. It has been shown to correlate with a wide range of surface phenomena such as wetting, adsorption and bioadhesion. Surface energy can also be considered to be a measure of the attractive forces between the molecules of a surface and a liquid. For most surfaces this attractive force is made up of two types of contributing forces: disperse and polar. The dispersive component is that due to London van der Waals forces which operate between all substances (polar and non polar), whereas the polar component is due to more discrete interactions such as hydrogen bonds. Hence, for example, a saturated hydrocarbon would be expected to have zero polar contribution to γ because it is purely disperse. Surface energy may be estimated using a number of experimental methods, including atomic force microscopy, surface force apparatus and inverse gas chromatography. The most common method of γ estimation is by contact angle measurement, which can be achieved using a variety of known methods.

It is known that microorganisms such as bacterial cells are often able to adhere to surfaces and that the ability to develop polymeric surfaces that are largely free of microorganisms can help reduce either the likelihood of infection in medical applications or cross contamination in other situations. Relevant microorganisms include, without limitation, bacteria (both Gram negative and Gram positive organisms) and fungi (eg Candida spp. and Aspergillus spp.). Medical devices where such polymers would be suitable include, without limitation, catheters, shunts, heart valves, corneal implants, and prosthetic joints. There are a number of other medical and non-medical applications for the polymers with non-microbe adherent surfaces. In addition, there are some applications where the selection of polymers which promote micro-organism adherence and biofilm development using the process of the present invention would be advantageous e.g. for the development of stable biofilms in fermenters for the production of useful metabolites and recombinant proteins, for biofilm in systems designed for purification or extraction of useful or harmful substances. The invention is thus also directed towards this goal.

The rate of materials development can be limited by the length of time it takes to produce and test new materials. One approach to accelerate this process is to produce an array of materials and assess them in parallel.

U.S. patent application Ser. No. 10/214,723 discloses the production of polymeric microarrays and the seeding of the biocompatible polymers with cells. This document does not, however, refer to any use of surface analysis techniques to tune the surface chemistry of the polymers.

Anderson et al, Nature Biotechnology (2004), volume 22(7), 863-866 discloses a minaturised cell compatible array of polymers and investigates the effects of the biocompatible polymers on human embryonic stem cell growth and differentiation. This document does not refer to avoidance of adherence or non-human cells.

US2002/0142304 describes a microarray of polymeric biomaterials on a cytophobic surface and the use of the microarray in a screening method. The screening method of the document is intended to screen for the ability of the biomaterials to affect cellular behaviour. The patent refers to the ability to control cellular behaviour eg adherence, proliferation, differentiation, gene expression for a number of unspecified applications. The arrays are intended to investigate the effect of a variety of polymeric biomaterials on a variety of aspects of cellular behaviour. The arrays are also said to be useful for investigating the effect of a variety of natural and synthetic compounds such as drugs, growth factors, proteins, polysaccharides, polynucleotides, lipids, etc on cellular behaviour. The patent describes a wide variety of cell types and a wide variety of polymers but is concerned in particular with mammalian cell properties. There is no disclosure of the concept of preparing an array with a deliberately varied range of surface energy values or the use of such an array to probe bacterial adherence in particular. Furthermore, the document does not recognise the issue of biofilm formation or the problems associated with biofilm formation on surfaces.

Prior art polymeric microarrays are created and seeded with cells without forming a detailed understanding of the surface energy. There is no disclosure in any of the prior art on how producing an array with a wide range of surface energies can assist in identification of polymers with suitably low microbial adherence.

It is an aim of the invention to overcome the various disadvantages of the prior art. More specifically, is an aim of the invention to provide a high-throughput method of creating polymers so that their surface properties, such as surface energy, can be correlated with the desirable effect of low microbial surface adherence. It is a further aim of the invention to provide polymers that have low microbial surface adherence. It is another aim to provide polymers which are resistant to biofilm formation. It is a further aim to produce polymers which promote development of stable biofilms.

The processes and compositions of the present invention satisfy some or all of the above aims.

We have created a microarray of polymers on a substrate which can be used to screen different bacteria or fungi both for the presence of little or no microbial adherence and also for detecting polymers which promote microbial adherence and biofilm development. We have also characterised the surface properties of the individual polymers in the microarray using new data capture procedures based on automated X-ray photoelectron spectroscopy (XPS) secondary ion mass spectrometry (SIMS) and water contact angle measurement.

In our process, picolitre spots of premixed monomer or monomers are introduced on to a slide and irradiated with UV light in order to initiate polymerisation of the monomer combinations in individual spots.

Some of the materials identified by the array are particularly suitable at resisting bacterial adherence. Cells are brought into contact with the array and then probed by a technique such as fluorescence imaging.

In one aspect, the invention relates to a process for screening an array containing two or more different synthetic polymers, the process comprising:
(a) providing a substrate surface and plurality of individual monomers in the liquid phase;
(b) depositing a plurality of individual aliquots of liquid contain a monomer or mixture of monomers at a plurality of discrete locations at sub-microlitre volumes onto the substrate surface;
(c) exposing the plurality of aliquots to initiating conditions to form individual polymer elements; and
(d) optionally determining the surface energy of the individual polymer elements.

The array can then be seeded with a microbial culture.

In a further step, the microbial adherence onto the polymeric element of the array is monitored by detection of the microorganism to identify polymers with low microbial adherence. Alternatively, the monitoring is performed to detect polymers with a high microbial adherence.

According to another aspect of the present invention, there is provided a process for screening an array containing two or more different synthetic polymers, the process comprising:
(a) providing a substrate surface and plurality of individual monomers in the liquid phase;
(b) depositing a plurality of individual aliquots of liquid contain a monomer or mixture of monomers at a plurality of discrete locations at sub-microlitre volumes onto the substrate surface;
(c) exposing the plurality of aliquots to initiating conditions to form individual polymer elements;
(d) optionally determining the surface energy of the individual polymer elements;
(e) seeding the array with a microbial culture; and
(f) monitoring microbial adherence onto the polymeric element of the array by detection of the microorganism to identify polymers with low microbial adherence.

Thus, as an alternative step (f) to replace step (f) in the above process involves monitoring microbial adherence onto the polymeric element of the array by detection of the microorganism to identify polymers which promote microbial adherence. These polymers find utility in forming biofilms etc.

In an embodiment, the surface energy of the individual polymer elements is determined by contact angle measurements.

In an embodiment, some or all of the plurality of individual aliquots include more than one type of monomer in the individual aliquots. Thus an individual aliquot may include two or more monomers.

In an embodiment, a proportion of the monomers is liquid at room temperature.

In an embodiment, a proportion of the liquid monomers is provided in a solvent.

In an embodiment, the step of exposing the plurality of aliquots to initiating conditions involves introducing an initiator to some or all of the plurality of individual aliquots using a liquid handling device, and preferably using a robotic liquid handling device.

In an embodiment, the initiator can be an organic radical initiator or a redox initiator.

In an embodiment, the step of exposing the plurality of aliquots to initiating conditions involves exposing the array to electromagnetic radiation and/or thermal radiation, optionally in the presence of an initiator which has been introduced into some or all of the plurality of individual aliquots. The electromagnetic radiation may be UV light.

In an embodiment, the initiator which is present in different individual aliquots is the same initiator. Equally, different initiators could be used for different aliquots.

In an embodiment, the substrate comprises a material selected from the group comprising: glass, ceramic, metal and plastic or a combination of one or more of these.

In an embodiment, the surface of the substrate has been modified to improve retention of the plurality of individual aliquots.

In an embodiment, the surface modification is provided by plasma etching, a polymer coating, chemical treatment or a combination of these.

In an embodiment, the monomers are monomers of polymers independently selected from the group comprising: substituted polyacrylates, substituted polyethers, substituted polycarbonates and substituted polyanhydrides. Some or all of the resulting polymers are biocompatible.

In an embodiment, the polymer includes a degree of unsaturation.

In an embodiment, each individual polymer is independently selected from the group comprising: monofunctional acrylate esters, polyfunctional acrylate esters, monofunctional methacrylate esters and polyfunctional methacrylate esters.

In an embodiment, each individual aliquot has a volume of 500 picolitres or less, and preferably 100 picolitres or less. The individual aliquots may be 50 picolitres or less. The individual aliquots do not all need to be of the same size.

In another embodiment, the plurality of individual aliquots are spaced at intervals of less than 500 μm, and preferably less than 100 μm. More preferably the spacing is less than 1 μm.

In another aspect, the invention also relates to novel polymers identified as a result of the screening process. Suitable polymers can be formed from one or more of the monomers identified below in the description, examples and Tables. The invention also relates to medical devices containing polymers identified using the process of the invention.

The invention also relates to the use of the process to identify bioadhesive or non-bioadhesive polymers which are suitable for use in medical applications.

The preparation of suitable arrays is described in US2004/0028804 and US2005/0019747 and the contents of these disclosures are specifically intended to form part of the present invention. These documents describe how to make arrays, details of various types of monomers, backing substrates and liquid handling methods.

The early stage biological response to man-made materials is controlled by surface chemistry and topography. In the case of implanted medical devices, this is further influenced by surface conditioning deposition of extracellular tissue fluid components (prior to eventual encapsulation as a foreign body). It is in this period that bacterial adherence occurs. It is not clear why certain polymeric surfaces promote bacterial adherence whilst others do not. Furthermore, there is no empirical way of predicting which polymers will promote adherence. We have found that tailoring the level of adherence provides polymers which have particular advantages in medical applications, relative to existing biopolymers.

For these studies, Pseudomonas aeruginosa PAO1 and Staphylococcus aureus 6390B and uropathogenic Escherichia coli (UPEC) were used as model Gram-negative and Gram-positive bacterial pathogens respectively given their distinct cell envelope structures and surface properties.

The invention thus provides an effective surface-energy based screening method. Polymers exhibiting the required surface energy, measured using the contact angle determination described below, thus will have utility as polymers which are not subject to attack from bacteria or fungus. The invention thus enables identification of materials which may find use in surgery or as implantable devices etc.

### Experimental Section

The present invention will now be illustrated by means of the following examples of synthetic polymer arrays and methods of assessing microorganism adherence. Included are procedures for preparing the arrays, methods of characterising surface properties and assays for determination of microorganism adherence.

Wetting is the contact between a liquid and a solid surface, resulting from intermolecular interactions when the two are brought together. Wetting is important in the bonding or adherence of two materials. The amount of wetting depends on the energies (or surface tensions) of the interfaces involved such that the total energy is minimized. The degree of wetting is described by the contact angle, the angle at which the liquid-vapor interface meets the solid-liquid interface. If the wetting is very favorable, the contact angle will be low, and the fluid will spread to cover a larger area of the surface. If the wetting is unfavorable, the fluid will form a compact droplet on the surface. Regardless of the amount of wetting, the shape of a drop wetted to a rigid surface is roughly a truncated sphere. A contact angle of 90° or greater generally characterizes a surface as not-wettable, and one less than 90° as wettable. In the context of water, a wettable surface may also be termed hydrophilic and a non-wettable surface hydrophobic. Superhydrophobic surfaces have contact angles greater than 150°, showing almost no contact between the liquid drop and the surface.

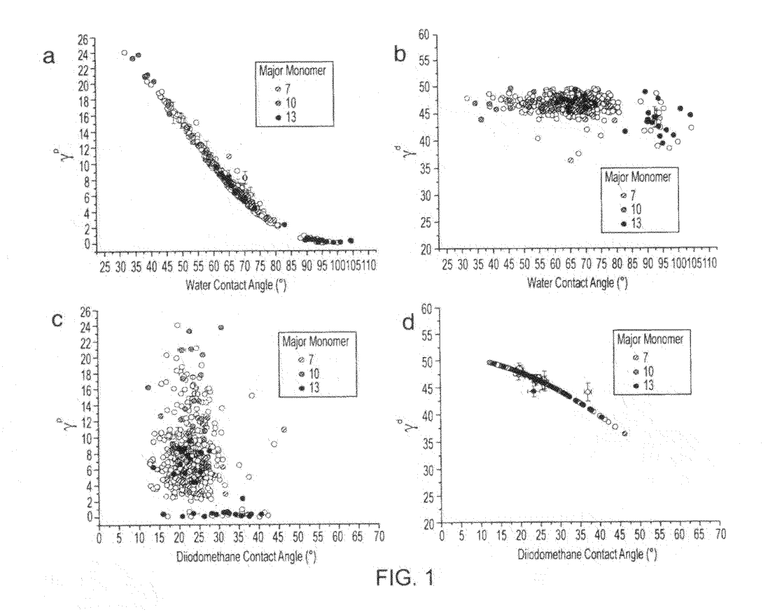

In the following Figures, FIG. 1a) illustrates water contact angle versus the polar component of surface energy, FIG. 1b) illustrates water contact angle versus dispersive component of surface energy for 480 polymers on array, FIG. 1c) illustrates Diiodomethane contact angle versus the polar component of surface energy, and FIG. 1d) illustrates Diiodomethane contact angle versus dispersive component of surface energy. Polymers containing major monomers 7, 10 and 13 have been highlighted to illustrate differences between polymer composition. The array contained 6 repeats of each of the 16 100% major monomers. The error bars represent the standard deviations for these 16 polymers to give an impression of the error of the technique.

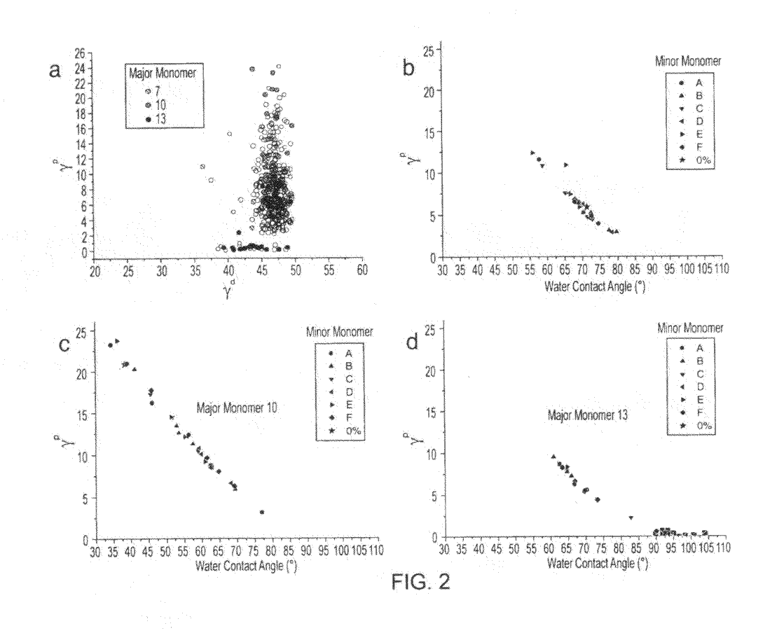

FIG. 2a) illustrates polar versus dispersive component for all 480 polymers, and Water Contact Angle versus polar component of surface energy for b) polymers containing monomer 10 as their major constituent c) polymers containing monomer 13 as their major constituent d) polymers containing monomer 7 as their major monomer. For figures b) to d) the black star represents the polymer containing 100% of the major monomer, i.e. no minor monomer additions.

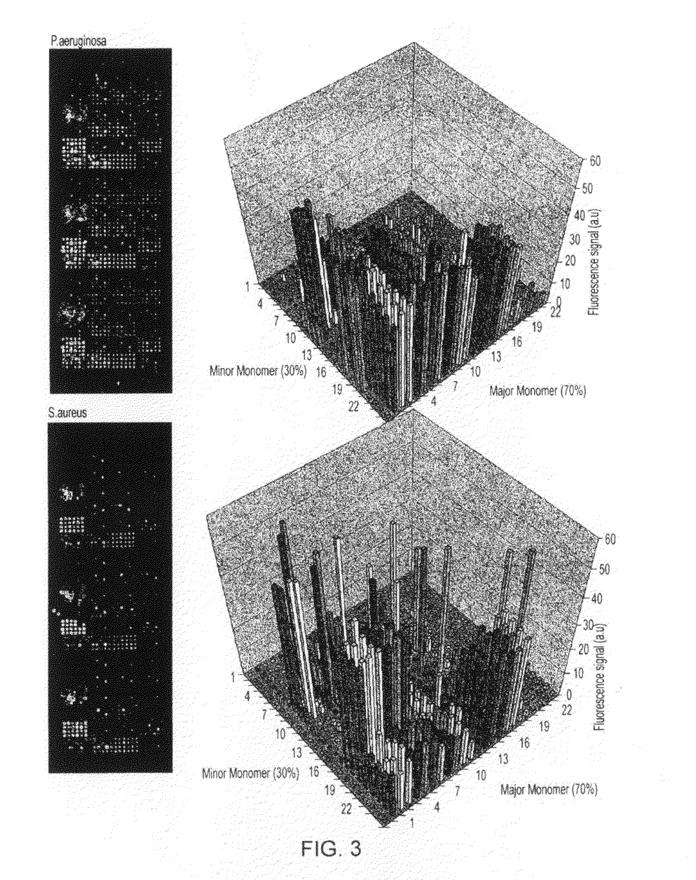

FIG. 3 illustrates the resulting fluorescence signals obtained using an array according to the present invention.

### EXAMPLES

### Example 1

Preparation of microarray of polymers: A microarray comprising 480 novel methacrylate/acrylate based polymers was synthesised from 16 major monomers which were mixed pairwise with 6 minor monomers in the following ratios—100:0, 90:10, 85:15, 80:20, 75:25 and 70:30 (FIG. 1a). A radical initiator was added to the monomer mixtures which were then spotted onto a poly hydroxyethyl methacrlyate (pHEMA) coated glass slide. They were then polymerised with ultraviolet light. Full details of array manufacture can be found elsewhere see for example, Anderson et al, Nature Biotech, (2004) 22(7), 863-866). Polymer composition was varied incrementally in order to investigate the effects of minor monomer concentration on γ (FIG. 1b).

### Example 2

### Measurement of Surface Energy

Procedure for contact angle measurements: Contact angles were determined for each polymer on the array prepared according to Example 1 using two liquids: Ultra pure water (18.2 M1 resistivity at 25° C.) and diiodomethane (>99% pure) (Aldrich). A DSA100 (Kruss) with a piezo-doser head was used to dispense a 100 pL droplet of each liquid onto the centre of each polymer spot on the array. Data acquisition was automated with the spot side profile of the back lit spot being recorded. A dual camera system was used, one to record a profile of the spot and the other to record a bird's eye view of the spot to ensure that the water droplet was deposited at the centre of each polymer. Modifications were made to the DSA100 reservoir to allow dosing of liquids with low interfacial tension such as diiodomethane. Data analysis involved following standard contact angle measurement procedures except that due to the small droplet size circle fitting was used instead of Young-Laplace.] 1. Taylor, M.; Urquhart, A. J.; Zelzer, M.; Davies, M. C.; Alexander, M. R., Picolitre water contact angle measurement on polymers. Langmuir Letters 2007, 23, (13), 6875-6878.] Polar and disperse γ values were calculated using the Owens and Wendt's model as described above. Macros were written to enable rapid γ calculations for the large dataset. The surface tension values of the liquids used are provided in Table 1.

TABLE 1
Surface tension values (including dispersive and polar values) for
test liquids

| | Surface | | |
|---|---|---|---|
| | tension | Dispersive component | Polar component |
| Liquid | (mN/m) | (mN/m) | (mN/m) |
| Ultra pure water | 72.8 | 21.8 | 51.0 |
| Diiodomethane | 50.8 | 50.8 | 0 |

Contact angle results and discussion: The automated acquisition and processing of all contact angle data and surface energy calculations were completed within three days. Since this is well within the timeframe required for biological evaluation of such a polymer microarray, this is considered to illustrate the high-throughput nature of the method in this application. Thus, both the water contact angle (WCA) and, upon solution of equation (1), the surface energy (γ^{p} & γ^{d}) was obtained for all of the 480 novel polymers. The WCA values of the polymers varied greatly from 31° to 104° indicating copolymer surfaces that were hydrophilic to hydrophobic (FIG. 2a). This was the intention when the monomers were chosen in the manufacture the array. When WCA is plotted against γ^{p} for all the polymers (FIG. 2a) it can be seen that as WCA measured on the copolymer decreases, the polar component of surface energy (γ^{p}) increased. Polar liquids (e.g. water) have low contact angles on materials with a high polar component because of increased affinity for the liquid with the surface due to increased hydrogen bonding between the liquid and the surface. Adhesive forces between the liquid molecules and the surface dominate over cohesive forces between the liquid molecules, hence the liquid spreads on contact. FIG. 2a illustrates the large range of γ^{p} values we have achieved, ranging from 0 to 24 mJ/m², demonstrating a significant ability to tune the polar component of a polymer surface by choice of monomeric constituents. In contrast the γ^{d} of the polymers is relatively invariant with WCA, with 90% of the polymers having a γ^{d} between 44 and 49 mJ/m² (FIG. 2b). γ^{d} is strongly related to the average atomic mass of the atoms at a surface, because London van der Waals forces increase in strength with increasing atomic size. Therefore, considering that the majority of the monomers used in this study have backbones containing only carbon and oxygen it is not surprising that there is so little variation in γ^{d} between the different polymers.

The diiodomethane contact angle (DCA) of the polymers varied from ˜13 to 47°. When DCA is plotted against γ^{p} it is obvious that there is no relationship between the two parameters (FIG. 2c) as diiodomethane is a completely non-polar liquid (Table 1). Therefore the adhesive force between the diiodomethane and the surface only arises due to London van der Waals forces. The polarity of the surface (and consequently the potential for hydrogen bonding) will not govern the DCA of a surface. Conversely, the DCA of the polymers decreases with increasing γ^{d}, due to the increasing adhesive force between the diiodomethane and the co-surfaces. This increase in dispersion force is due to the increasing strength of London van der Waals forces between the liquid and the surface as the surface becomes more hydrophobic.

If γ^{p} is plotted against γ^{d} it can be observed that the polymers have a narrow range of γ^{d} values with a wide range of γ^{p} values (FIG. 3a). Polymers containing major monomer 13 have the largest range of γ^{d} values (˜39 to 48 mJ/m²) with a moderate variation in γ^{p} values (˜0 to 9 mJ/m²). In contrast, polymers containing major monomer 7 group quite closely with similar γ^{p} and γ^{d} values. Monomer 7 is notable as the only monomer containing a terminal phenyl group. Comparison with polymers that do have a large variation (e.g. those contain monomer 13) suggests that this reflects a lack of the minor monomer constituents at the surface, which is supported by ToF-SIMS analysis of polymers containing this monomer. Hence, all polymers in this group have similar γ^{p} and γ^{d} values to the polymer containing 100% major monomer 7.

A review of the contact angle data from the copolymer array reveals that monomer structure has a major influence on surface energies. To illustrate this point, three major monomer groups (7, 10 & 13) have been selected in FIG. 2a to highlight the effect of monomer chemistry on WCA and γ^{p} of the resultant copolymer surface. Major monomer 7 is a monoacrylate with a pendent chain containing phenyl and hydroxyl functionalities. Major monomer 10 is another monoacrylate, but in this case its pendent chain only terminates with a hydroxyl functionality. Finally, major monomer 13 is a triacrylate containing a hydroxyl functional group. All three monomers have a polar hydroxyl functional group within their structure, yet the polymers containing the three major monomers differ greatly in WCA (˜35-105°). Polymers containing monomer 10 as their major constituent are grouped towards the hydrophilic end of the scale, whereas those containing major monomer 13 tend towards the hydrophobic (FIG. 2a). The large difference in the wettability of these polymers can be related to their chemical structure. Monomer 10 shows the most hydrophilic WCA range which may be consistent with preferential orientation of the polar hydroxyl end groups towards the polymer surface. This phenomenon has been observed previously for a monoacrylate monomer with hydroxyl end groups. The monoacrylate monomer 7 has a side chain with both hydroxyl and phenyl functional groups and interestingly sits in a WCA range between monomer 10 and polystyrene (˜90°),⁹ which would indicate an energetic compromise between surface hydroxyl and phenyl groups. Finally monomer 13 shows the most hydrophobic range in WCA which would indicate that the triacrylate nature of the monomer increases the degree of polymer cross-linking and thus the hydroxyl group is not presented at the surface due to steric hindrance.

The addition of minor monomers had a significant effect on the γ^{p} of most of the polymers. Minor monomer E generally increases the γ^{p} of a polymer (e.g. major monomers 7 & 13) unless the polymer already has a very high γ^{p} (e.g. 100% major monomer 10) in which case it will decrease it (FIG. 3b-d). This is perhaps not surprising as monomer E contains a polar dimethylamino end-group. In contrast minor monomer D always decreases the γ^{p} of the polymer. Monomer D contains six fluorine atoms which have a weak hydrogen bonding ability when covalently bonded to carbon, hence a decreased γ^{p} when it is added as a minor constituent.

### Example 3

Bacteria and culture conditions: P. aeruginosa (strain PAO1 pUCP18::gfpmut3.1, S. aureus (strain SH1000 pMK4 pXYLA::gfp) and UPEC (pUCP18::gfpmut3.1) were and UPEC routinely grown in Luria-Bertani broth (LB) and Brain Heart Infusion broth (BHI) respectively. All bacterial cells for experimentation were grown to early stationary phase in the specified nutrient both at 37° C. in a 100 ml baffled Erlenmeyer flasks with shaking at 200 rpm unless otherwise stated. Cells were harvested by centrifugation for 10 mins at 4000 rpm (1500 g), washed three times in 25 ml volumes of PBS (10 mM Na2HPO4, 1.8 mM KH2PO4, 140 mM NaCl, 2.5 mM KCl, pH 7.2) and resuspended in the working buffer (DPBS, Dulbecco's phosphate buffered saline) by vortex mixing. Bacterial cell suspensions were adjusted to 1.0 (±0.1) by optical density measurements at 600 nm using a UV-VISBLE spectrometer (Elmer Perkin). The spectral characteristics of both GFP-marked bacteria were characterized using a Cary Eclipse Fluorescence spectrophotometer (Varian, UK). All spectra were acquired in 50 mM Tris buffer (1 mM EDTA, pH 7.5).

Combinatorial Array Preparation: Synthetic polymer array chips were prepared according to Example 1 and dried at <50 mTorr for at least 7 days prior to use. The chips were sterilized by exposure to UV for 30 min on each side, and then washed twice with PBS for ≈30 min and then twice with 1×10 ml PBS before bacterial adherence assays, to remove any residual surface contamination.

Hybridization study and microarray scanning: Before hybridization, biomaterial microarrays were pre-wet with 1 mL of 1×PBS for 5 min at room temperature. PBS was removed from the array by shaking and then a 300 μL aliquot of optically adjusted GFP-marked bacterial cell suspension (≈1×10⁸ CFU/ml) was added to the microarray. Cells were evenly distributed on the array surface by covering it with a small piece of parafilm, and the arrays were hybridized for 10 min at room temperature in the dark. After incubation, unbound cells were washed off by delivering 10×1 mL aliquots of 1×PBS over the slide. Slides were allowed to air dry and scanned with a GenePix™ 4000AL four colour fluorescence microarray scanner (Axon Instruments) with an excitation wavelength of 488 nm Fluorescence was detected through a 505-550 nm band pass filter. Images were acquired and processed using the GenePix® Pro microarray image analysis software (version 6.0). The fluorescence images from two arrays are presented in Fig NEW DATA, where one sample has been exposed to P. aeruginosa and the other S aureus.

Table 2 indicates suitable monomers which can also be used in a polymer array according to the present invention.

TABLE 2
a

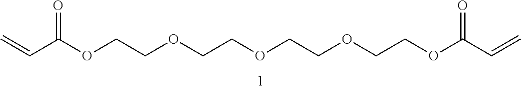

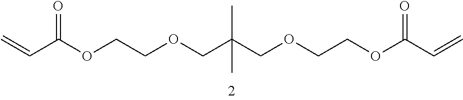

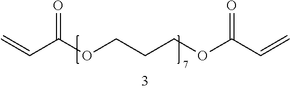

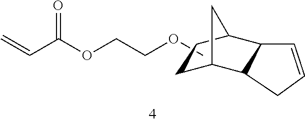

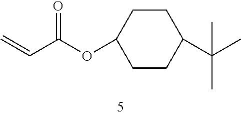

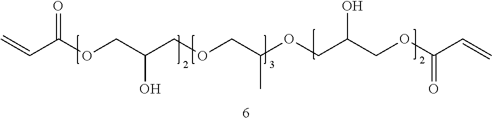

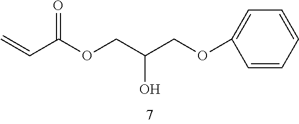

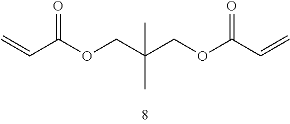

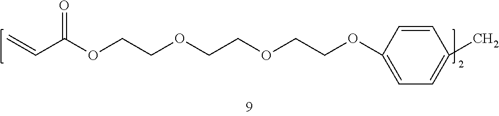

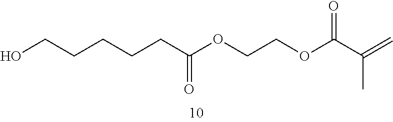

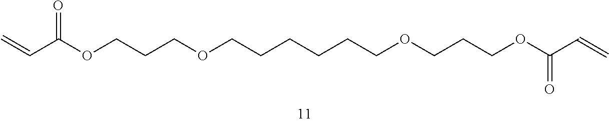

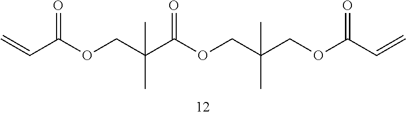

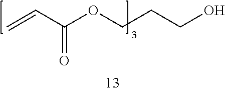

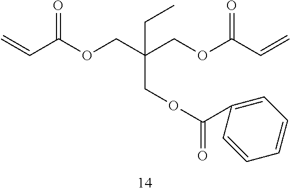

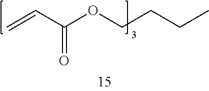

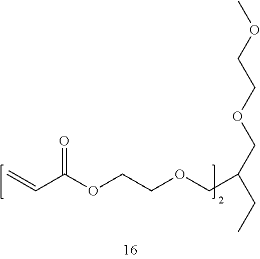

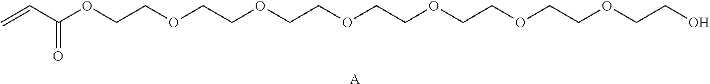

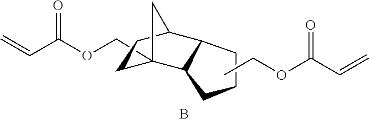

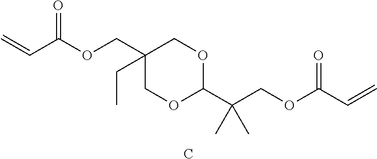

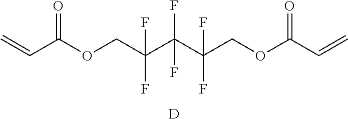

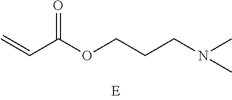

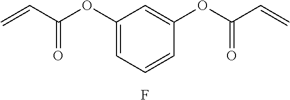

b
100% 1
90% 1 10% A
85% 1 15% A
80% 1 20% A
75% 1 25% A
70% 1 30% A
90% 1 10% B
85% 1 15% B
80% 1 20% B
75% 1 25% B
70% 1 30% B
90% 1 10% C
85% 1 15% C
80% 1 20% C
75% 1 25% C
70% 1 30% C
90% 1 10% D
85% 1 15% D
80% 1 20% D
75% 1 25% D
70% 1 30% D
90% 1 10% E
85% 1 15% E
80% 1 20% E
75% 1 25% E
70% 1 30% E
90% 1 10% F
85% 1 15% F
80% 1 20% F
75% 1 25% F
70% 1 30% F
Table 2 shows.
a) Structures of the 16 major monomers and 6 minor monomers which were used to create a polymer array.
b) The ratios of monomers used to create the 31 polymers containing major monomer 1. The same ratios were used for each of the 16 major monomers to create 480 novel polymers.

Previous work in the area has focused on investigating the adherence between mammalian cells and microarrays. We have found that it is possible to provided a microarray containing a range of polymers having a deliberately varied range of surface energies and hence wettabilities in order to probe the adherence of bacteria to the polymer. More importantly, the present invention allows the screening of materials which are resistant to the formation of biofilms when exposed to microorganisms. The adherence or otherwise of bacteria to polymers whilst problematic, is not a significant issue. More importantly, a method of screening for the inhibition of biofilm formation would represent a substantial advantage in a number of medical and non-medical applications. Biofilms are quite different from simple bacterial coatings. In a bacterial coating, individual bacteria act as discrete entities. However in a biofilm the film as a whole is subject to a property known as “quorum sensing” in which individual components which were originally individual bacterial units act in concert and sense one another. Individual units signal via chemical means to one another and effectively act in concert to form a biofilm which has distinct and different properties from the underlying individual components. The biofilm forms as a propagating slimy mass which occludes the surface of a material and which is hard to remove. To date, there has been no method for determining materials upon which biofilm propagation can be inhibited. The present invention provides a method and materials which inhibit biofilm formation on polymeric surfaces. The polymers of the present invention are synthetic polymers. In a preferred embodiment, the polymers are based on acrylate or methacrylate units. Table 3 indicates a preferred group of monomers which can be used in array according to the present invention.

TABLE 3
Monofunctional acrylate esters
45,496-6 MONO-2-(ACRYLOYLOXY)ETHYL SUCCINATE
40,811-5 (2-(ACRYLOYLOXY)ETHYL)TRIMETHYLAMMONIUM METHYL
SULFATE, 80 WT. % SOLUTION IN WATER
41,321-6 2-(4-BENZOYL-3-HYDROXYPHENOXY)ETHYL ACRYLATE, 98%
47,557-2 2-BUTOXYETHYL ACRYLATE, 97%
23,492-3 BUTYL ACRYLATE, 99+%
32,718-2 TERT-BUTYL ACRYLATE, 98%
46,754-5 4-TERT-BUTYLCYCLOHEXYL ACRYLATE, 90%
40,555-8 2-CYANOETHYL ACRYLATE, TECH.40,530-2 DICAPROLACTONE 2-
(ACRYLOYLOXY)ETHYL ESTER
40,897-2 2-(DIETHYLAMINO)ETHYL ACRYLATE, 95%
40,829-8 DI(ETHYLENE GLYCOL) ETHYL ETHER ACRYLATE, TECH., 90+%
40,754-2 DI(ETHYLENE GLYCOL) 2-ETHYLHEXYL ETHER ACRYLATE
33,095-7 2-(DIMETHYLAMINO)ETHYL ACRYLATE, 98%
41,565-0 3-(DIMETHYLAMINO)PROPYL ACRYLATE, 95%
47,442-8 2,2,3,3,4,4,5,5,6,6,7,7-DODECAFLUOROHEPTYL ACRYLATE, 97%
47,437-1 3,3,4,4,5,5,6,6,7,8,8,8-DODECAFLUORO-7-
(TRIFLUOROMETHYL)OCTYL ACRYLATE, 97%
47,444-4 2,2,3,3,4,4,5,5,6,6,7,7,8,8,9,9,10,10,11,11-EICOSAFLUOROUNDECYL
ACRYLATE, 97%
40,830-1 2-ETHOXYETHYL ACRYLATE, 98%
E970-6 ETHYL ACRYLATE, 99%
40,796-8 ETHYLENE GLYCOL DICYCLOPENTENYL ETHER ACRYLATE
40,891-3 ETHYLENE GLYCOL METHYL ETHER ACRYLATE, 98%
40,833-6 ETHYLENE GLYCOL PHENYL ETHER ACRYLATE
29,081-5 2-ETHYLHEXYL ACRYLATE, 98%
47,435-5 HENEICOSAFLUORODODECYL ACRYLATE, 96%
47,448-7 3,3,4,4,5,5,6,6,7,7,8,8,9,9,10,10,10-HEPTADECAFLUORODECYL
ACRYLATE, 97%
47,447-9 HEPTADECAFLUORO-2-HYDROXYUNDECYL ACRYLATE, 96%
44,375-1 2,2,3,3,4,4,4-HEPTAFLUOROBUTYL ACRYLATE, 97%
47,443-6 2,2,3,3,4,4,5,5,6,6,7,7,8,8,9,9-HEXADECAFLUORONONYL
ACRYLATE, 97%
47,439-8 HEXADECAFLUORO-9-(TRIFLUOROMETHYL)DECYL ACRYLATE,
97%
47,445-2 2,2,3,4,4,4-HEXAFLUOROBUTYL ACRYLATE, 95%
36,765-6 1,1,1,3,3,3-HEXAFLUOROISOPROPYL ACRYLATE, 99%
40,890-5 HEXYL ACRYLATE, 98%
27,557-3 4-HYDROXYBUTYL ACRYLATE, 96%
29,281-8 2-HYDROXYETHYL ACRYLATE, 96%
40,736-4 2-HYDROXY-3-PHENOXYPROPYL ACRYLATE
37,093-2 HYDROXYPROPYL ACRYLATE, 95%, MIXTURE OF ISOMERS
47,555-6 ISOAMYL ACRYLATE, 98%
39,210-3 ISOBORNYL ACRYLATE, TECH.
43,630-5 ISOBUTYL ACRYLATE, 99+%
40,895-6 ISODECYL ACRYLATE
43,742-5 ISOOCTYL ACRYLATE
44,731-5 LAURYL ACRYLATE, TECH., 90%
36,076-7 2-(METHACRYLOYLOXY)ETHYL ACETOACETATE, 95%
31,751-9 METHYL 2-ACETAMIDOACRYLATE, 98%
M2,730-1 METHYL ACRYLATE, 99%
47,565-3 NEOPENTYL GLYCOL ACRYLATE BENZOATE
41,215-5 NEOPENTYL GLYCOL METHYL ETHER PROPOXYLATE (2 PO/OH)
ACRYLATE, AVERAGE MN CA. 288
47,450-9 4,4,5,5,6,6,7,7,7-NONAFLUORO-2-HYDROXYHEPTYL ACRYLATE,
96%
40,969-3 OCTADECYL ACRYLATE, 97%
47,446-0 4,4,5,5,6,7,7,7-OCTAFLUORO-2-HYDROXY-6-
(TRIFLUOROMETHYL)HEPTYL ACRYLATE, 96%
47,440-1 2,2,3,3,4,4,5,5-OCTAFLUOROPENTYL ACRYLATE, 97%
47,436-3 3,3,4,4,5,6,6,6-OCTAFLUORO-5-(TRIFLUOROMETHYL)HEXYL
ACRYLATE, 97%
47,096-1 2,2,3,3,3-PENTAFLUOROPROPYL ACRYLATE, 98%
40,758-5 POLY(2-CARBOXYETHYL) ACRYLATE, AVERAGE MW CA. 170
46,982-3 POLY(ETHYLENE GLYCOL) ACRYLATE, AVERAGE MN CA. 375
45,499-0 POLY(ETHYLENE GLYCOL) METHYL ETHER ACRYLATE,
AVERAGE MN CA. 454
40,735-6 POLY(ETHYLENE GLYCOL) 4-NONYLPHENYL ETHER ACRYLATE,
AVERAGE MN CA. 450
40,732-1 POLY(ETHYLENE GLYCOL) PHENYL ETHER ACRYLATE,
AVERAGE MN CA. 236
41,231-7 POLY(ETHYLENE GLYCOL) PHENYL ETHER ACRYLATE,
AVERAGE MN CA. 280
40,734-8 POLY(ETHYLENE GLYCOL) PHENYL ETHER ACRYLATE,
AVERAGE MN CA. 324
46,981-5 POLY(PROPYLENE GLYCOL) ACRYLATE, AVERAGE MN CA. 475
47,558-0 POLY(PROPYLENE GLYCOL) METHYL ETHER ACRYLATE,
AVERAGE MN CA. 202
41,018-7 POLY(PROPYLENE GLYCOL) METHYL ETHER ACRYLATE,
AVERAGE MN CA. 260
40,755-0 POLY(PROPYLENE GLYCOL) 4-NONYLPHENYL ETHER
ACRYLATE, AVERAGE MN CA. 419
37,192-0 2,2,3,3-TETRAFLUOROPROPYL ACRYLATE, 96%
40,827-1 TETRAHYDROFURFURYL ACRYLATE
47,449-5 4,4,5,5,6,6,7,7,8,8,9,9,9-TRIDECAFLUORO-2-HYDROXYNONYL
ACRYLATE, 96%
47,434-7 3,3,4,4,5,5,6,6,7,7,8,8,8-TRIDECAFLUOROOCTYL ACRYLATE, 97%
29,772-0 2,2,2-TRIFLUOROETHYL ACRYLATE, 99%
47,514-9 3-(TRIMETHOXYSILYL)PROPYL ACRYLATE, 92%
42,402-1 3,5,5-TRIMETHYLHEXYL ACRYLATE
35,878-9 TRIMETHYL 2-PHOSPHONOACRYLATE, 95%
34,749-3 TRIMETHYLSILYL METHACRYLATE, 98%
43,461-2 VINYL ACRYLATE, 98%
acrylate esters, polyfunctional
45,498-2 3-(ACRYLOYLOXY)-2-HYDROXYPROPYL METHACRYLATE
41,355-0 BISPHENOL A ETHOXYLATE (1 EO/PHENOL) DIACRYLATE,
AVERAGE MN CA. 424
41,209-0 BISPHENOL A ETHOXYLATE (2 EO/PHENOL) DIACRYLATE,
AVERAGE MN CA. 512
41,210-4 BISPHENOL A ETHOXYLATE (4 EO/PHENOL) DIACRYLATE,
AVERAGE MN CA. 688
41,116-7 BISPHENOL A GLYCEROLATE (1 GLYCEROL/PHENOL)
DIACRYLATE
47,564-5 BISPHENOL A PROPOXYLATE (2 PO/PHENOL) DIACRYLATE,
TECH.
41,175-2 1,3-BUTANEDIOL DIACRYLATE, 98%
41,174-4 1,4-BUTANEDIOL DIACRYLATE, TECH., 90%
43,743-3 DI(ETHYLENE GLYCOL) DIACRYLATE, TECH., 75%
40,728-3 DIPENTAERYTHRITOL PENTA-/HEXAACRYLATE
40,836-0 DI(TRIMETHYLOLPROPANE) TETRAACRYLATE, AVERAGE M.W.
466
48,079-7 ETHYLENE GLYCOL DIACRYLATE, TECH., 90%
49,634-0 2-
(ETHYL((HEPTADECAFLUOROOCTYL)SULFONYL)AMINO)ETHYL
ACRYLATE
49,677-4 5-ETHYL-5-(HYDROXYMETHYL)-BETA,BETA-DIMETHYL-1,3-
DIOXANE-2-ETHANOL DIACRYLATE
47,580-7 GLYCEROL 1,3-DIGLYCEROLATE DIACRYLATE, TECH.
41,212-0 GLYCEROL PROPOXYLATE (1 PO/OH) TRI-ACRYLATE, AVERAGE
MN CA. 428
24,681-6 1,6-HEXANEDIOL DIACRYLATE, TECH., 90%
49,713-4 1,6-HEXANEDIOL ETHOXYLATE DIACRYLATE
49,693-6 1,6-HEXANEDIOL PROPOXYLATE DIACRYLATE
46,205-5 3-HYDROXY-2,2-DIMETHYLPROPYL 3-HYDROXY-2,2-
DIMETHYLPROPIONATE DIACRYLATE
49,678-2 HYDROXYPIVALYL HYDROXYPIVALATE BIS(6-
(ACRYLOYLOXY)HEXANOATE)
40,825-5 NEOPENTYL GLYCOL DIACRYLATE
41,213-9 NEOPENTYL GLYCOL ETHOXYLATE (1 EO/OH) DIACRYLATE,
AVERAGE MN CA. 300
41,214-7 NEOPENTYL GLYCOL PROPOXYLATE (1 PO/OH) DIACRYLATE,
AVERAGE MN CA. 328
40,752-6 PENTAERYTHRITOL DIACRYLATE MONOSTEARATE
49,694-4 PENTAERYTHRITOL PROPOXYLATE TRIACRYLATE
40,826-3 PENTAERYTHRITOL TETRAACRYLATE
24,679-4 PENTAERYTHRITOL TRIACRYLATE, TECH.
47,562-9 POLY(ETHYLENE GLYCOL) DIACRYLATE, AVERAGE MN CA. 258
43,744-1 POLY(ETHYLENE GLYCOL) DIACRYLATE, AVERAGE MN CA. 575
45,500-8 POLY(ETHYLENE GLYCOL) DIACRYLATE, AVERAGE MN CA. 700
40,558-2 POLY(MELAMINE-CO-FORMALDEHYDE), ACRYLATED, 65 WT. %
SOLUTION IN TRIPROPYLENE GLYCOL DIACRYLATE
45,501-6 POLY(PROPYLENE GLYCOL) DIACRYLATE, AVERAGE MN CA. 540
45,502-4 POLY(PROPYLENE GLYCOL) DIACRYLATE, AVERAGE MN CA. 900
47,577-7 PROPYLENE GLYCOL GLYCEROLATE DIACRYLATE, TECH.
41,233-3 SOYBEAN OIL, EPOXIDIZED ACRYLATE
43,747-6 2,2′,6,6′-TETRABROMOBISPHENOL A ETHOXYLATE (1
EO/PHENOL) DIACRYLATE
39,880-2 TETRA(ETHYLENE GLYCOL) DIACRYLATE, TECH.
40,638-4 S,S′-THIODI-4,1-PHENYLENE BIS(THIOMETHACRYLATE), 99%
47,334-0 1,3,5-TRIACRYLOYLHEXAHYDRO-1,3,5-TRIAZINE, 98%
49,666-9 TRICYCLO(5.2.1.0(2,6))DECANEDIMETHANOL DIACRYLATE
47,566-1 TRIMETHYLOLPROPANE BENZOATE DIACRYLATE
41,587-1 TRIMETHYLOLPROPANE ETHOXYLATE (1EO/OH) METHYL
ETHER DIACRYLATE
40,907-3 TRIMETHYLOLPROPANE ETHOXYLATE (1 EO/OH) TRIACRYLATE,
AVERAGE MN CA. 428
41,217-1 TRIMETHYLOLPROPANE ETHOXYLATE (7/3 EO/OH)
TRIACRYLATE, AVERAGE MN CA. 604
41,219-8 TRIMETHYLOLPROPANE ETHOXYLATE (14/3
EO/OH)TRIACRYLATE, AVERAGE MN CA. 912
40,756-9 TRIMETHYLOLPROPANE PROPOXYLATE (1 PO/OH)
TRIACRYLATE, AVERAGE MN CA. 470
40,757-7 TRIMETHYLOLPROPANE PROPOXYLATE (2 PO/OH)
TRIACRYLATE, AVERAGE MN CA. 644
24,680-8 TRIMETHYLOLPROPANE TRIACRYLATE, TECH.
24,683-2 TRI(PROPYLENE GLYCOL) DIACRYLATE, TECH., MIXTURE OF
ISOMERS
47,578-5 TRI(PROPYLENE GLYCOL) GLYCEROLATE DIACRYLATE
methacrylate esters, monofunctional
45,496-6 MONO-2-(ACRYLOYLOXY)ETHYL SUCCINATE
40,811-5 (2-(ACRYLOYLOXY)ETHYL)TRIMETHYLAMMONIUM METHYL
SULFATE, 80 WT. % SOLUTION IN WATER
41,321-6 2-(4-BENZOYL-3-HYDROXYPHENOXY)ETHYL ACRYLATE, 98%
47,557-2 2-BUTOXYETHYL ACRYLATE, 97%
23,492-3 BUTYL ACRYLATE, 99+%
32,718-2 TERT-BUTYL ACRYLATE, 98%
46,754-5 4-TERT-BUTYLCYCLOHEXYL ACRYLATE, 90%
40,555-8 2-CYANOETHYL ACRYLATE, TECH.
40,530-2 DICAPROLACTONE 2-(ACRYLOYLOXY)ETHYL ESTER
40,897-2 2-(DIETHYLAMINO)ETHYL ACRYLATE, 95%
40,829-8 DI(ETHYLENE GLYCOL) ETHYL ETHER ACRYLATE, TECH., 90+%
40,754-2 DI(ETHYLENE GLYCOL) 2-ETHYLHEXYL ETHER ACRYLATE
33,095-7 2-(DIMETHYLAMINO)ETHYL ACRYLATE, 98%
41,565-0 3-(DIMETHYLAMINO)PROPYL ACRYLATE, 95%
47,442-8 2,2,3,3,4,4,5,5,6,6,7,7-DODECAFLUOROHEPTYL ACRYLATE, 97%
47,437-1 3,3,4,4,5,5,6,6,7,8,8,8-DODECAFLUORO-7-
(TRIFLUOROMETHYL)OCTYL ACRYLATE, 97%
47,444-4 2,2,3,3,4,4,5,5,6,6,7,7,8,8,9,9,10,10,11,11-EICOSAFLUOROUNDECYL
ACRYLATE, 97%
40,830-1 2-ETHOXYETHYL ACRYLATE, 98%
E970-6 ETHYL ACRYLATE, 99%
40,796-8 ETHYLENE GLYCOL DICYCLOPENTENYL ETHER ACRYLATE
40,891-3 ETHYLENE GLYCOL METHYL ETHER ACRYLATE, 98%
40,833-6 ETHYLENE GLYCOL PHENYL ETHER ACRYLATE
29,081-5 2-ETHYLHEXYL ACRYLATE, 98%
47,435-5 HENEICOSAFLUORODODECYL ACRYLATE, 96%
47,448-7 3,3,4,4,5,5,6,6,7,7,8,8,9,9,10,10,10-HEPTADECAFLUORODECYL
ACRYLATE, 97%
47,447-9 HEPTADECAFLUORO-2-HYDROXYUNDECYL ACRYLATE, 96%
44,375-1 2,2,3,3,4,4,4-HEPTAFLUOROBUTYL ACRYLATE, 97%
47,443-6 2,2,3,3,4,4,5,5,6,6,7,7,8,8,9,9-HEXADECAFLUORONONYL
ACRYLATE, 97%
47,439-8 HEXADECAFLUORO-9-(TRIFLUOROMETHYL)DECYL ACRYLATE,
97%
47,445-2 2,2,3,4,4,4-HEXAFLUOROBUTYL ACRYLATE, 95%
36,765-6 1,1,1,3,3,3-HEXAFLUOROISOPROPYL ACRYLATE, 99%
40,890-5 HEXYL ACRYLATE, 98%
27,557-3 4-HYDROXYBUTYL ACRYLATE, 96%
29,281-8 2-HYDROXYETHYL ACRYLATE, 96%
40,736-4 2-HYDROXY-3-PHENOXYPROPYL ACRYLATE
37,093-2 HYDROXYPROPYL ACRYLATE, 95%, MIXTURE OF ISOMERS
47,555-6 ISOAMYL ACRYLATE, 98%
39,210-3 ISOBORNYL ACRYLATE, TECH.
43,630-5 ISOBUTYL ACRYLATE, 99+%
40,895-6 ISODECYL ACRYLATE
43,742-5 ISOOCTYL ACRYLATE
44,731-5 LAURYL ACRYLATE, TECH., 90%
36,076-7 2-(METHACRYLOYLOXY)ETHYL ACETOACETATE, 95%
31,751-9 METHYL 2-ACETAMIDOACRYLATE, 98%
M2,730-1 METHYL ACRYLATE, 99%
47,565-3 NEOPENTYL GLYCOL ACRYLATE BENZOATE
41,215-5 NEOPENTYL GLYCOL METHYL ETHER PROPOXYLATE (2 PO/OH)
ACRYLATE, AVERAGE MN CA. 288
47,446-0 4,4,5,5,6,7,7,7-OCTAFLUORO-2-HYDROXY-6-
(TRIFLUOROMETHYL)HEPTYL ACRYLATE, 96%
47,440-1 2,2,3,3,4,4,5,5-OCTAFLUOROPENTYL ACRYLATE, 97%
47,436-3 3,3,4,4,5,6,6,6-OCTAFLUORO-5-(TRIFLUOROMETHYL)HEXYL
ACRYLATE, 97%
47,096-1 2,2,3,3,3-PENTAFLUOROPROPYL ACRYLATE, 98%
40,758-5 POLY(2-CARBOXYETHYL) ACRYLATE, AVERAGE MW CA. 170
46,982-3 POLY(ETHYLENE GLYCOL) ACRYLATE, AVERAGE MN CA. 375
45,499-0 POLY(ETHYLENE GLYCOL) METHYL ETHER ACRYLATE,
AVERAGE MN CA. 454
40,735-6 POLY(ETHYLENE GLYCOL) 4-NONYLPHENYL ETHER ACRYLATE,
AVERAGE MN CA. 450
40,732-1 POLY(ETHYLENE GLYCOL) PHENYL ETHER ACRYLATE,
AVERAGE MN CA. 236
41,231-7 POLY(ETHYLENE GLYCOL) PHENYL ETHER ACRYLATE,
AVERAGE MN CA. 280
40,734-8 POLY(ETHYLENE GLYCOL) PHENYL ETHER ACRYLATE,
AVERAGE MN CA. 324
46,981-5 POLY(PROPYLENE GLYCOL) ACRYLATE, AVERAGE MN CA. 475
47,558-0 POLY(PROPYLENE GLYCOL) METHYL ETHER ACRYLATE,
AVERAGE MN CA. 202
41,018-7 POLY(PROPYLENE GLYCOL) METHYL ETHER ACRYLATE,
AVERAGE MN CA. 260
40,755-0 POLY(PROPYLENE GLYCOL) 4-NONYLPHENYL ETHER
ACRYLATE, AVERAGE MN CA. 419
37,192-0 2,2,3,3-TETRAFLUOROPROPYL ACRYLATE, 96%
40,827-1 TETRAHYDROFURFURYL ACRYLATE
47,449-5 4,4,5,5,6,6,7,7,8,8,9,9,9-TRIDECAFLUORO-2-HYDROXYNONYL
ACRYLATE, 96%
47,434-7 3,3,4,4,5,5,6,6,7,7,8,8,8-TRIDECAFLUOROOCTYL ACRYLATE, 97%
29,772-0 2,2,2-TRIFLUOROETHYL ACRYLATE, 99%
47,514-9 3-(TRIMETHOXYSILYL)PROPYL ACRYLATE, 92%
42,402-1 3,5,5-TRIMETHYLHEXYL ACRYLATE
35,878-9 TRIMETHYL 2-PHOSPHONOACRYLATE, 95%
34,749-3 TRIMETHYLSILYL METHACRYLATE, 98%
43,461-2 VINYL ACRYLATE, 98%
methacrylate esters, polyfunctional
45,498-2 3-(ACRYLOYLOXY)-2-HYDROXYPROPYL METHACRYLATE
51,615-5 2-AMINOETHYL METHACRYLATE HYDROCHLORIDE, 90%
49,675-8 BIS(2-(METHACRYLOYLOXY)ETHYL) PHOSPHATE
15,632-9 BISPHENOL A DIMETHACRYLATE
41,211-2 BISPHENOL A ETHOXYLATE (2 EO/PHENOL) DIMETHACRYLATE,
AVERAGE MN CA. 540
45,505-9 BISPHENOL A ETHOXYLATE (15 EO/PHENOL) DIMETHACRYLATE
47,315-4 BIS(3-SULFOPROPYL) ITACONATE, DIPOTASSIUM SALT
40,899-9 1,3-BUTANEDIOL DIMETHACRYLATE
23,495-8 1,4-BUTANEDIOL DIMETHACRYLATE, 95%
40,900-6 DI(ETHYLENE GLYCOL) DIMETHACRYLATE, 95%
43,690-9 DIURETHANE DIMETHACRYLATE, MIXTURE OF ISOMERS
33,568-1 ETHYLENE GLYCOL DIMETHACRYLATE, 98%
49,635-9 2-
(ETHYL((HEPTADECAFLUOROOCTYL)SULFONYL)AMINO)ETHYL
METHACRYLATE
43,689-5 GLYCEROL DIMETHACRYLATE, TECH., 85%, MIXTURE OF
ISOMERS
41,173-6 1,6-HEXANEDIOL DIMETHACRYLATE
40,824-7 NEOPENTYL GLYCOL DIMETHACRYLATE
41,892-7 POLY(ACRYLONITRILE-CO-BUTADIENE-CO-ACRYLIC ACID),
DICARBOXY TERMINATED GLYCIDYL METHACRYLATE DIESTER
46,980-7 POLY(ETHYLENE GLYCOL) DIMETHACRYLATE, AVERAGE MN
CA. 330
40,951-0 POLY(ETHYLENE GLYCOL) DIMETHACRYLATE, AVERAGE MN
CA. 550
43,746-8 POLY(ETHYLENE GLYCOL) DIMETHACRYLATE, AVERAGE MN
CA. 875
45,503-2 POLY(PROPYLENE GLYCOL) DIMETHACRYLATE
48,371-0 1,14-TETRADECANEDIOL DIMETHACRYLATE, TECH.
40,638-4 S,S′-THIODI-4,1-PHENYLENE BIS(THIOMETHACRYLATE), 99%
26,154-8 TRI(ETHYLENE GLYCOL) DIMETHACRYLATE, 95%
24,684-0 TRIMETHYLOLPROPANE TRIMETHACRYLATE, TECH.
Product Name
1H,1H,2H,2H-Heptadecafluorodecyl acrylate
1H,1H,2H,2H-Heptadecafluorodecyl methacrylate
1H,1H,3H-Hexafluorobutyl acrylate
1H,1H,3H-Hexafluorobutyl methacrylate
1H,1H,3H-Tetrafluoropropyl methacrylate
1H,1H,5H-Octafluoropentyl acrylate
1H,1H,5H-Octafluoropentyl methacrylate
1H,1H,7H-Dodecafluoroheptyl methacrylate
1H,1H-Heptafluorobutyl acrylate
2,2,2-Trifluoroethyl acrylate
2,2,2-Trifluoroethyl methacrylate
Hexafluoro-iso-propyl_methacrylate
Pentafluorophenyl acrylate
Pentafluorophenyl methacrylate, 95%
Octafluorohexyl acrylate

1. A process for screening an array containing two or more different synthetic polymers, the process comprising:
(a) providing a substrate surface and plurality of individual monomers in the liquid phase;
(b) depositing a plurality of individual aliquots of liquid contain a monomer or mixture of monomers at a plurality of discrete locations at sub-microlitre volumes onto the substrate surface;
(c) exposing the plurality of aliquots to initiating conditions to form individual polymer elements; and
(d) optionally determining the surface energy of the individual polymer elements.

2. The process of claim 1, wherein some or all of the plurality of individual aliquots include more than one type of monomer in the individual aliquots.

3. The process of claim 1, wherein a proportion of the monomers is liquid at room temperature.

4. The process of claim 1, wherein a proportion of the liquid monomers is provided in a solvent.

5. The process of claim 1 wherein the step of exposing the plurality of aliquots to initiating conditions involves introducing an initiator to some or all of the plurality of individual aliquots using a liquid handling device, and preferably using a robotic liquid handling device.

6. The process of claim 5, wherein the initiator is an organic radical initiator or a redox initiator.

7. The process of claim 1 wherein the step of exposing the plurality of aliquots to initiating conditions involves exposing the array to electromagnetic radiation and/or thermal radiation, optionally in the presence of an initiator which has been introduced into some or all of the plurality of individual aliquots.

8. The process of claim 5 wherein the initiator which is present in different individual aliquots is the same initiator.

9. The process of claim 1 wherein the substrate comprises a material selected from the group comprising: glass, ceramic, metal and plastic or a combination of one or more of these.

10. The process of claim 9, wherein the surface of the substrate has been modified to improve retention of the plurality of individual aliquots.

11. The process of claim 10, wherein the surface modification is provided by plasma etching, a polymer coating, chemical treatment or a combination of these.

12. The process of claim 1 wherein the monomers are monomers of at least one polymers independently selected from the group comprising: substituted polyacrylates, substituted polyethers, substituted polycarbonates and substituted polyanhydrides.

13. The process of claim 12, wherein some or all of the polymers formed on the process are biocompatible.

14. The process of claim 12, wherein the polymer includes a degree of unsaturation.

15. The process of claim 12, wherein each individual polymer is independently selected from the group comprising: monofunctional acrylate esters, polyfunctional acrylate esters, monofunctional methacrylate esters and polyfunctional methacrylate esters.

16. The process of claim 1 wherein each individual aliquot has a volume of 500 picolitres or less, and preferably 100 picolitres or less.

17. The process of claim 1 wherein the surface energy of the individual polymer elements is determined by contact angle measurement.

18. The process of claim 1 wherein the process includes the further steps:
(e) seeding the array with a microbial culture; and
(f) monitoring microbial adherence onto the polymeric element of the array by detection of the microorganism to identify polymers with low microbial adherence or which promote microbial adherence.

19. The process of claim 2, wherein a proportion of the monomers is liquid at room temperature.

19. The process of claim 2, wherein a proportion of the liquid monomers is provided in a solvent.
